(19) United States
(12) Patent Application Publication
(10) Pub. No.: US 2025/0384506 A1
(43) Pub. Date: Dec. 18, 2025

(54) STUDENT PERFORMANCE PREDICTION METHOD, APPARATUS, ELECTRONIC DEVICE, AND STORAGE MEDIUM

(71) Applicant: Central China Normal University, Wuhan (CN)

(72) Inventors: Xiuling HE, Wuhan (CN); Yangyang Li, Wuhan (CN); Leyao Zhang, Wuhan (CN); Xiong Xiao, Wuhan (CN); Zhipin Peng, Wuhan (CN); Chun Gan, Wuhan (CN)

(21) Appl. No.: 19/237,010

(22) Filed: Jun. 13, 2025

(30) Foreign Application Priority Data
Jun. 14, 2024 (CN) 202410767603.8

(51) Int. Cl. G06Q 50/20; G06N 3/045; G06N 3/084

(52) U.S. Cl. CPC G06Q 50/205; G06N 3/045; G06N 3/084

(57) ABSTRACT

A student performance prediction method, apparatus, electronic device, and computer-readable storage medium, wherein the student performance prediction method includes: obtaining learning behavior data corresponding to different target behaviors among multiple behavior categories of a student within a preset time period; and aggregating the learning behavior data corresponding to the different target behaviors in a preset time unit, and performing feature fusion on the aggregated data separately for each behavior category to obtain a category feature set, determining the multiple category feature sets organized in chronological order as a category feature time series set, inputting the category feature time series set into a pre-trained feature reconstruction network to obtain a reconstructed time series set, and inputting the reconstructed time series set into a student performance prediction model to obtain a performance prediction result for the student. The above student performance prediction method can objectively and efficiently predict the student performance.

### CROSS-REFERENCE TO RELATED APPLICATIONS

The present disclosure claims priority to Chinese Patent Application No. 202410767603.8, entitled “STUDENT PERFORMANCE PREDICTION METHOD, APPARATUS, ELECTRONIC DEVICE, AND STORAGE MEDIUM,” filed on Jun. 14, 2024, which is incorporated by reference herein in its entirety.

### TECHNICAL FIELD

The present disclosure relate to the field of educational informatization technology, and more particularly, to a student performance prediction method, apparatus, electronic device, and computer-readable storage medium.

### BACKGROUND

In current teaching practices, student performance prediction can assist teachers in teaching and students in learning. Specifically, the student performance prediction (i.e., a student's future academic performance at a predetermined future timeframe) allows the teachers to detect at-risk students timely, thereby facilitating timely teacher interventions (e.g., implementing dropout prevention initiatives).

In existing technology, the student performance prediction method primarily relies on subjective assessments conducted by teachers of various subjects. Such process depends on the experience of the teachers, takes a long time, may generate different assessment results from different teachers, and demands a high level of teacher experience. Therefore, there is an urgent need for an objective and accurate method to predict student performance.

### SUMMARY

In view of the limitations described above, the present disclosure aims to provide a student performance prediction method, apparatus, electronic device, and computer-readable storage medium, which can predict the student performance objectively and efficiently.

In a first aspect, the present disclosure provides a student performance prediction method, including:
obtaining learning behavior data corresponding to different target behaviors among multiple behavior categories of a student within a preset time period;
aggregating the learning behavior data corresponding to the different target behaviors in a preset time unit, performing feature fusion on the aggregated data separately for each behavior category to obtain a category feature set, and determining the multiple category feature sets organized in chronological order as a category feature time series set;
inputting the category feature time series set into a pre-trained feature reconstruction network to obtain a reconstructed time series set; and
inputting the reconstructed time series set into a student performance prediction model to obtain a performance prediction result for the student.

In some embodiments, before the inputting the reconstructed time series set into a pre-trained student performance prediction model, the method further includes:
obtaining training time series data; and
performing joint training of the student performance prediction model for at least two tasks using the training time series data.

In some embodiments, the performing the joint training of the student performance prediction model for at least two tasks using the training time series data includes:
masking some of the training time series data to obtain masked training time series data; and
performing the joint training of the student performance prediction model for at least two tasks using the masked training time series data and unmasked time series data, wherein the joint training of the student performance prediction mode includes predicting original time series data before masking for the masked training time series data and predicting student performance.

In some embodiments, before the obtaining learning behavior data corresponding to different target behaviors among multiple behavior categories of a student within a preset time period, the method further includes:
obtaining behavior data of multiple behavior features;
calculating behavior feature values of the behavior features based on the behavior data;
determining the behavior feature corresponding to the behavior feature value satisfying a preset first condition as the target behavior; and
classifying the obtained multiple target behaviors according to the multiple behavior categories, and determining the behavior category to which the target behavior belongs.

In some embodiments, the performing feature fusion on the aggregated data separately based on the behavior categories to obtain a category feature set includes:
determining aggregation time periods to which all aggregated data belongs, and for the aggregated data within a same aggregation time period, selecting a maximum value of the aggregated data corresponding to the target behavior of the same behavior category as a category feature value of the same behavior category within the same aggregation time period; and
summarizing the category feature values of each behavior category within each aggregation time period to obtain the category feature set.

In some embodiments, the feature reconstruction network is a feature distillation network.

In some embodiments, the multiple behavior categories include four types of behavior category which includes an interactive behavior category, a constructive behavior category, an active behavior category, and a passive behavior category.

In a second aspect, the present disclosure further provides a student performance prediction apparatus, including:
a data acquisition module, configured to obtain learning behavior data corresponding to different target behaviors among multiple behavior categories of a student within a preset time period;
a data processing module, configured to aggregate the learning behavior data corresponding to different target behaviors in a preset time unit, perform feature fusion on the aggregated data separately for each behavior category to obtain a category feature set, and determine the multiple category feature sets organized in chronological order as a category feature time series set;
a feature reconstruction module, configured to input the category feature time series set into a pre-trained feature reconstruction network to obtain a reconstruct the temporal set; and
a performance prediction module, configured to input the reconstructed time series set into a student performance prediction model to obtain a performance prediction result for the student.

In a third aspect, the present disclosure further provides an electronic device including a memory, a processor, and a computer program stored in the memory and capable of running in the processor, wherein, when being executed by the processor, the computer program implements the steps in the above student performance prediction method.

In a fourth aspect, the present disclosure further provides a computer-readable storage medium with a computer program stored thereon, wherein, when being executed by a processor, the computer program implements the steps in the above student performance prediction method.

The student performance prediction method of the present disclosure includes: obtaining the learning behavior data corresponding to different target behaviors among multiple behavior categories of a student within the preset time period; aggregating the learning behavior data corresponding to the different target behaviors in the preset time unit, performing feature fusion on the aggregated data separately for each behavior category to obtain the category feature set, and determining the multiple category feature sets organized in chronological order as the category feature time series set; inputting the category feature time series set into the pre-trained feature reconstruction network to obtain the reconstructed time series set; and inputting the reconstructed time series set into the student performance prediction model to obtain a performance prediction result for the student. The embodiment of the present disclosure can quickly predict the student performance based on the learning behavior data of the student without subjective evaluation from teachers, which allows the thinking ability of the learner to be predicted objectively and efficiently.

### BRIEF DESCRIPTION OF DRAWINGS

To describe the technical solutions of the embodiments of this application more clearly, the following briefly introduces the accompanying drawings required for describing the embodiments. Apparently, the accompanying drawings in the following description show only some embodiments of this application, and those skilled in the art may still derive other drawings from these accompanying drawings without creative efforts.

FIG. 1 is a flowchart of a student performance prediction method in accordance with an embodiment of the present disclosure;

FIG. 2 is a structural schematic diagram of a student performance prediction apparatus in accordance with an embodiment of the present disclosure; and

FIG. 3 is a schematic diagram of a hardware structure of an electronic device in accordance with an embodiment of the present disclosure.

### DESCRIPTION OF EMBODIMENTS

To make the objectives, technical solutions, and advantages of the embodiments of this application clearer, the technical solutions in the embodiments of this application will be described clearly and comprehensively below in conjunction with the accompanying drawings. Obviously, the described embodiments are only a part of the embodiments of the present disclosure, not all of them. Based on the embodiments of the present disclosure, all other embodiments obtained by those of ordinary skill in the art without creative effort fall within the scope of protection of the present disclosure.

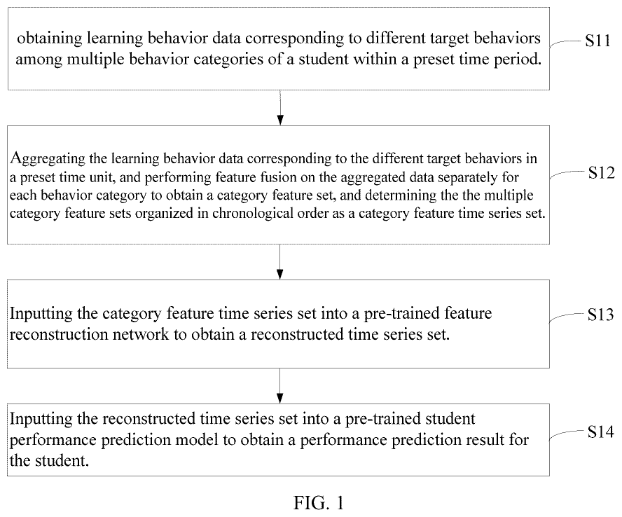

Referring to FIG. 1, which is a flowchart of a student performance prediction method in accordance with an embodiment of the present disclosure. The method described in this embodiment can be applied to electronic devices, which can be intelligent terminals such as personal computers and servers. As shown in FIG. 1, the student performance prediction method includes steps as follows.

Step S11, obtaining learning behavior data corresponding to different target behaviors among multiple behavior categories of a student within a preset time period.

In this embodiment, the student can be of any grade and study any subject.

In some embodiments, the learning behavior data of the student within the preset time period can be collected from a learning interaction platform.

In this embodiment, the learning behavior data is represented by numbers such as click counts.

In some embodiments, the preset time period can be a semester, half a semester, or other time periods.

In some embodiments, the multiple behavior categories can include at least two types of behavior category, such as an in-class learning type and an out-of-class learning type. Each type of behavior category can include multiple different target behaviors. The learning behavior data refers to the data corresponding to the target behavior related to the learning behavior in a learning process of a certain subject or multiple subjects for a certain student. For example, the target behavior includes: a learning progress, a participation (including the student's participation in classroom discussions, group activities, and online forums), an interaction, a learning time, a learning path, an emotional feedback during the learning process (such as satisfaction and frustration), a use of learning tools, and a learning strategy.

Furthermore, in an alternative embodiment of the present disclosure, the multiple behavior categories include four types of behavior category, namely, an interactive behavior category, a constructive behavior category, an active behavior category, and a passive behavior category.

In some embodiments, the target behavior within the interactive behavior category includes: a discussion forum, a collaborative communication, and sharing information between courses and teachers.

The target behavior within the constructive behavior category includes: a course testing, a participation in surveys, and a participation in external testing activities (such as extracurricular tests or competitions).

The target behavior within the active behavior category includes: visiting a homepage, searching for platform resources, downloading platform resources, entering other sites that have been launched within the course, visiting links, searching for Wikipedia content, opening course-related files, accessing glossaries, visiting information-related websites and activities, simulating seminars, entering course-related interfaces, and repeating activities.

The behavior feature within the passive behavior category includes: a supplementary material (such as a supplementary material related to the learning content) and online content.

In this embodiment, by selecting the learning behavior data corresponding to different target behaviors within various types of behavior category, the diversity of data can be enriched, thereby enhancing the accuracy of the prediction. Furthermore, by selecting the learning behavior data from the four types of behavior category: the interactive behavior category, the constructive behavior category, the active behavior category, and the passive behavior category, the comprehensiveness of data selection can be improved, which further improves the accuracy of the prediction.

Furthermore, in an optional embodiment of the present disclosure, before the obtaining learning behavior data corresponding to different target behaviors among multiple behavior categories of a student within a preset time period, the method further includes:
obtaining behavior data of multiple behavior features;
calculating behavior feature values of the multiple behavior features based on the behavior data;
determining the behavior feature corresponding to the behavior feature value satisfying a preset first condition as the target behavior; and
classifying the obtained multiple target behavior according to the multiple behavior categories, and determining the behavior category to which the target behavior belongs.

In this embodiment, the behavior feature value of the behavior feature can be calculated through the following formula:

$${S}^{′} = max ( \frac{1}{\vert S \vert} {\sum }_{{x}_{i} ∈ S} I ( {x}_{i} ; y ) - \frac{1}{{\vert S \vert}^{2}} {\sum }_{{x}_{i} , {x}_{j} ∈ s} I ( {x}_{i} ; {x}_{j} ) )$$

Wherein, S is a feature subset of the behavior feature (the specific data corresponding to the feature subset which can be represented by a set of vectors). xᵢ, xⱼ are the behavior features in the feature subset S, wherein i=j=1, 2, . . . , n, and n represents the number of the feature vectors (i.e., the specific data of the number of the behavior features). y is a target variable (i.e., the performance of the student, such as “pass” or “fail”), I(xᵢ; y) indicates mutual information (MI) between the behavior feature xᵢ and the target variable y, I(xᵢ; xⱼ) indicates the MI between the behavior feature xᵢ and the behavior feature xⱼ, that is, the mutual information between any two behavior features.

In this embodiment, the determining the behavior feature corresponding to the behavior feature value satisfying a preset first condition as the target behavior includes:
arranging the multiple behavior feature values obtained through calculation in a descending order, and obtaining the behavior features corresponding to top N behavior feature values as the target behaviors; or
obtaining the behavior features corresponding to the multiple behavior feature values that are greater than a preset threshold as the target behaviors.

For example, 20 behavior features are obtained, and after the behavior feature values are calculated for feature selection, the 12 behavior features with the highest scores are obtained. The 12 behavior features are then classified into four types based on the behavior category (such as the interactive behavior category, the constructive behavior category, the active behavior category, and the passive behavior category), that is, which category each behavior feature belongs to among the four types of behavior category is determined: the interactive behavior category, the constructive behavior category, the active behavior category, and the passive behavior category.

In this embodiment, a higher behavior feature value indicates a stronger correlation between the behavior feature and a prediction result. By screening multiple behavior features to identify the target behavior, feature factors that are highly correlated with the prediction result can be obtained, thereby improving both the accuracy and efficiency of prediction.

Step S12, aggregating the learning behavior data corresponding to the different target behaviors in a preset time unit, and performing feature fusion on the aggregated data separately for each behavior category to obtain a category feature set, and determining the multiple category feature sets organized in chronological order as a category feature time series set.

In this embodiment, the preset time unit can be a week. That is, the learning behavior data corresponding to the different target behaviors are aggregated on a weekly basis. For example, the data of a certain target behavior within a week is aggregated into a single value (such as the total number of clicks on a certain webpage within a week, which is used as the aggregated feature value for the week).

For example, the obtained learning behavior data of the student interacting with the learning platform forms a time sequence x1:L={x1, x2, . . . , xL}E RLXC with a length of L, wherein L indicates a length of the learning behavior time sequence (such as a learning duration based on a week unit or a day unit). xᵢ is an aggregated feature value of the learning behaviors within a i^{th} time period (such as each week in a week unit), and C is the number of the learning behaviors.

Wherein, each xᵢ∈R^{C} represents a feature vector of the learning behaviors within the i^{th} time period. The feature vector xᵢ=(xᵢ₁, xᵢ₂, . . . , x_{iC}), wherein xᵢⱼ represents the aggregated data of a j-th learning behaviors in the i^{th} time period.

The entire learning behavior time sequence x(1:L) can be represented as a matrix with a shape of L×C, wherein each row is a feature vector for a time period (such as one week):

$${x}_{( 1 : L )} = ( \begin{matrix}{x}_{11} & … & {x}_{1 C} \\ ⋮ & ⋱ & ⋮ \\ {x}_{L 1} & … & {x}_{LC}\end{matrix} ) .$$

The performing feature fusion on the aggregated data separately for each behavior category refers to performing the feature fusion on the aggregated data corresponding to the target behaviors within the same behavior category to obtain the category feature value for each behavior category. After the feature fusion is performed on all the behavior categories, the set of all category feature values forms the category feature set. The feature fusion is performed by: for each behavior category, calculating an average value of the aggregated data corresponding to the target behaviors within the same behavior category, and using the average value as the category feature for that behavior category. After the feature fusion is performed on all behavior categories, the obtained category features form a category feature set. All chronologically-organized category feature sets (i.e., the multiple category feature sets organized in chronological order) form the category feature time series set.

In the aforementioned x(1:L), if there are C learning behaviors in x₁₁ to x_{1c}, then the feature fusion is respectively performed on the data in x₁₁ to x_{1c} for each behavior category to obtain the category feature set.

For example, among C target behaviors, which target behaviors belong to the same behavior category is determined, and then the feature fusion is performed on the aggregated data of this behavior category to obtain the fused result as the category feature. If x₁₁ to x₁₅ all belong to Category A, then the feature fusion is performed on x₁₁ to x₁₅ (such as calculating the average of x₁₁ to x₁₅) to obtain the result as the category feature of Category A in the X₁ time period. Similarly, the feature fusion is performed on the data of L rows, that is, the data of rows x₁₁ to x_{L1} by behavior category to obtain the category feature time series set which includes L rows of data (representing L time periods), and each row of data has a category feature value of a different behavior category.

Furthermore, in an optional embodiment of the present disclosure, the performing feature fusion on the aggregated data separately for each behavior category to obtain a category feature set includes:
determining aggregation time periods to which all aggregated data belong; for the aggregated data within the same aggregation time period, selecting a maximum value of the aggregated data corresponding to the target behavior of the same behavior category as the category feature value for the same behavior category within the same aggregation time period; and
summarizing the category feature values of each behavior category within each aggregation time period to obtain the category feature set.

In this embodiment, the aggregation time period to which the aggregated data belongs is the time period corresponding to the data being aggregated. For example, if there are 10 weeks of aggregated data corresponding to 10 different target behaviors, the aggregated data corresponding to different target behaviors in the first week belongs to the same aggregation time period, and the aggregated data corresponding to different target behaviors in the second week belongs to the same aggregation time period.

For example, there are 20 weeks of aggregated data. The target behaviors for a certain week include a behavior a, a behavior b, a behavior c, a behavior d, a behavior e, a behavior f, and a behavior g. The behavior a and the behavior b belong to a first behavior category, the behavior c and the behavior d belong to a second behavior category, the behavior e belongs to a third behavior category, and the behavior d belongs to a fourth behavior category. In the aggregated data, the maximum aggregated data from the behavior a and the behavior b is selected as the category feature value for the first behavior category of the week, and the maximum aggregated data from the behavior c and the behavior d is selected as the category feature value for the second behavior category of the week. The aggregated data from the behavior e is selected as the category feature value for the third behavior category of the week. The maximum aggregated data from the behavior f and the behavior g is selected as the category feature value for the fourth behavior category of the week.

In this embodiment, the category feature values of each behavior category within each aggregation time period are summarized to obtain the category feature set, which reduces the computational dimension compared to step-by-step feature aggregation. At the same time, according to experimental results, such method improves the accuracy of the prediction result.

Step S13, inputting the category feature time series set into a pre-trained feature reconstruction network to obtain a reconstructed time series set.

In this embodiment, the pre-trained feature reconstruction network is used to reconstruct the category feature time series set.

Experiments show that in this embodiment, the accuracy of the prediction result is improved after the reconstruction of the category feature time series set.

Furthermore, in an optional embodiment of the present disclosure, the feature reconstruction network is a feature distillation network.

In this embodiment, the feature distillation network can include a student network and a teacher network.

Furthermore, in an optional embodiment of the present disclosure, the feature distillation network includes: a first student LSTM, a feature distillation module, and a second student LSTM.

In this embodiment, the reconstructed time series set is outputted through the feature distillation module. The network structures of the first student LSTM and the second student LSTM can be identical.

The feature distillation network utilizes the input data as the training target, and is trained based on a backpropagation algorithm and an optimization algorithm to guide the network in extracting a temporal dependency and sequential information of the input sequence data. The LSTM unit is capable of processing a long sequence dependency, and includes a forget gate, an input gate, and an output gate that facilitate the memory and transmission of time series information. These gating mechanisms work together to ensure that the LSTM unit updates the state appropriately at each time step.

In this embodiment, the formula for the feature distillation network can be simplified as follows:

$$Z = LSTM ( X ) ;$$

$$\hat{X} = LSTM ( Z ) .$$

As shown in FIG. 1, wherein X represents the input sequence and X={x₁, x₂, xᵢ}, wherein xᵢ is an original value input to the feature distillation network, \hat{X} is a predicted value output by the last layer of the neural network in the feature distillation network, Z is the reconstructed sequence output by the feature distillation module after the first student LSTM, and \hat{X} is a clone of the original input sequence. The feature distillation network utilizes a hidden state output by the previous LSTM layer (i.e., the first student LSTM) and then passes the hidden state to the last LSTM layer (i.e., the second student LSTM), which optimizes the LSTM unit through the backpropagation by minimizing the difference between the output value and the original input value.

In this embodiment, the feature distillation network is pre-trained to optimize the extraction of features (such as the category feature time series set) of the input time sequence data by adjusting the network weights. Therefore, the training is unsupervised training, and the loss function is defined as the mean squared error between the input sequence and the output sequence.

Step S14, inputting the reconstructed time series set into a pre-trained student performance prediction model to obtain a performance prediction result for the student.

The pre-trained student performance prediction model can be a BERT model. The BERT model employs a multi-head attention mechanism, and processes the input sequence through an attention mechanism, a residual connection with normalization, and a stacked feedforward neural network structure.

The specific content of the performance prediction result can vary depending on the task during the training of the student performance prediction model. For example, the obtained performance prediction result for the student can be the result of passing or failing in a certain subject or multiple subjects at a certain time in the future.

Furthermore, in an optional embodiment of the present disclosure, before the inputting the reconstructed time series set into a pre-trained student performance prediction model, the method includes:
obtaining training time series data; and
performing joint training of the student performance prediction model for at least two tasks using the training time series data.

The training data can be the learning behavior data corresponding to different target behaviors among multiple behavior categories of multiple students.

Furthermore, the training data can be pre-processed through data cleaning and outlier removal. After being pre-processed, the training data is aggregated in a preset time unit and the feature fusion within the same behavior category is performed. Additionally, a feature reconstruction network can be utilized for the reconstruction, and the reconstructed data then can be used to train the student performance prediction model.

In this embodiment, the accuracy of the prediction made by the student performance prediction model can be improved through the joint training.

Furthermore, in an optional embodiment of the present disclosure, the performing joint training of the student performance prediction model for at least two tasks using the training time series data includes:
masking some of the training time series data to obtain masked training time series data; and
performing the joint training of the student performance prediction model for at least two tasks using the masked training time series data and unmasked training time series data, wherein the joint training includes predicting original training time series data before masking for the masked training time series data and predicting student performance.

The masking some of the training time series data includes the following steps: randomly selecting 15% of target training time series data from the entire training time series data for masking, and then performing the following operations on each piece of target training time series data: (1) randomly masking 80% of the sequences within the target training time series data (for example, replacing 80% of the sequences with a Masked sequence, which can be represented as an all-ones sequence); (2) Selecting 10% of the sequences and randomly replacing the selected sequences with sequences from the unmasked training time series data; (3) keeping 10% of the sequences unchanged.

Furthermore, the predicting original training time series data before masking for the masked training time series data includes predicting the masked training time series data and the corresponding original time series data before masking.

In this embodiment, the weights and biases in the model are updated through backpropagation of the neural network. In some embodiments, for Task 1 (predicting the original time series data before masking for the masked training time series data), a MSE loss function (i.e., the mean squared error loss function) can be used. For Task 2 (predicting the student performance), a multi-class cross-entropy loss function can be used.

Furthermore, in an optional embodiment of the present disclosure, the loss function of the joint training includes:

$${L}_{t o t a l} = \frac{1}{n} {\sum }_{i}^{n} {w}_{i} {L}_{i} ;$$

Wherein, wᵢ is a learnable weight of Task i, and Lᵢ is a computational loss of Task i (i.e., a loss value calculated by the loss function of Task i).

In some embodiments, a value of w₁ (i.e., Task 1) is between 0.78 and 0.80, and A value of w₂ is between 0.65 and 0.72.

After initialization of wᵢ, the weights are updated every time the backpropagation of deep learning is continued, thereby simultaneously optimizing the two tasks and ensuring that the total loss is minimized as much as possible, avoiding simply combining the losses of the two tasks directly through addition. Furthermore, the emphasis on different tasks can be dynamically adjusted by learning the weights, thereby improving the prediction accuracy of the trained model.

In this embodiment, the joint training includes predicting the original time series data before masking and predicting the student performance based on the masked training time series data. Such bidirectional task allows each time series to indirectly observe itself, improving the bidirectional learning capability of the model. Therefore, the student performance prediction model in this embodiment is more powerful than the shallow concatenation of left-to-right models or left-to-right and right-to-left models, and can improve the accuracy of the student performance prediction model.

The student performance prediction method of the present disclosure includes: obtaining the learning behavior data corresponding to different target behaviors among multiple behavior categories of a student within the preset time period; aggregating the learning behavior data corresponding to the different target behaviors in the preset time unit, performing feature fusion on the aggregated data separately for each behavior category to obtain the category feature set, and determining the multiple category feature sets organized in chronological order as the category feature time series set; inputting the category feature time series set into the pre-trained feature reconstruction network to obtain the reconstructed time series set; and inputting the reconstructed time series set into the student performance prediction model to obtain a performance prediction result for the student. The embodiment of the present disclosure can quickly predict the student performance based on the learning behavior data of the student without subjective evaluation from teachers, which allows the thinking ability of the learner to be predicted objectively and efficiently.

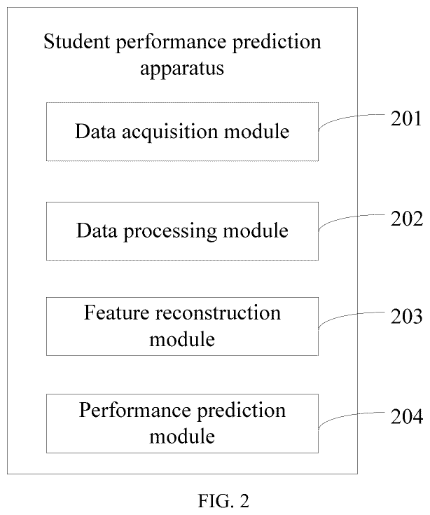

Referring to FIG. 2, which is a schematic diagram of the structure of a student performance prediction apparatus provided in an embodiment of the present disclosure. For ease of explanation, only the parts related to the embodiment of the present disclosure are shown. The apparatus can be installed in an electronic device, which can be an intelligent terminal such as a personal computer or a server. The student performance prediction apparatus includes a data acquisition module 201, a data processing module 202, a feature reconstruction module 203, and a performance prediction module 204.

The data acquisition module 201 is configured to obtain learning behavior data corresponding to different target behaviors among multiple behavior categories of a student within a preset time period.

In this embodiment, the student can be of any grade and study any subject.

In some embodiments, the learning behavior data of the student within the preset time period can be collected from a learning interaction platform.

In this embodiment, the learning behavior data is represented numerically, such as a number of clicks.

In some embodiments, the preset time period can be a semester, half a semester, or other time periods.

In some embodiments, the multiple behavior categories can include at least two types of behavior category, such as an in-class learning type and an out-of-class learning type. Each type of behavior category can include multiple different target behaviors. The learning behavior data refers to the data corresponding to the target behavior related to the learning behavior in a learning process of a certain subject or multiple subjects for a certain student. For example, the target behavior includes: a learning progress, a participation (including the student's participation in classroom discussions, group activities, and online forums), an interaction, a learning time, a learning path, an emotional feedback during the learning process (such as satisfaction and frustration), a use of learning tools, and a learning strategy.

Furthermore, in an alternative embodiment of the present disclosure, the multiple behavior categories includes four types of behavior category, including an interactive behavior category, a constructive behavior category, an active behavior category, and a passive behavior category.

In some embodiments, the target behavior within the interactive behavior category includes: a discussion forum, a collaborative communication, and sharing information between courses and teachers.

The target behavior within the constructive behavior category includes: a course testing, a participation in surveys, and a participation in external testing activities (such as extracurricular tests or competitions).

The target behavior within the active behavior category includes: visiting a homepage, searching for platform resources, downloading platform resources, entering other sites that have been launched within the course, visiting links, searching for Wikipedia content, opening course-related files, accessing glossaries, visiting information-related websites and activities, simulating seminars, entering course-related interfaces, and repeating activities.

The behavior feature within the passive behavior category includes: a supplementary material (such as a supplementary material related to the learning content) and online content.

In this embodiment, by selecting the learning behavior data corresponding to different target behaviors within various types of behavior category, the diversity of data can be enriched, thereby enhancing the accuracy of the prediction. Furthermore, by selecting the learning behavior data from the four types of behavior category: the interactive behavior category, the constructive behavior category, the active behavior category, and the passive behavior category, the comprehensiveness of data selection can be improved, further improving the accuracy of the prediction.

Furthermore, in an optional embodiment of the present disclosure, before the data acquisition module 201 obtains the learning behavior data corresponding to different target behaviors among multiple behavior categories of the student within the preset time period, the apparatus further includes a behavior selection module configured to:
obtain behavior data of multiple behavior features;
calculate behavior feature values of the multiple behavior features based on the behavior data; and
determine the behavior feature corresponding to the behavior feature value satisfying a preset first condition as the target behavior, classify the obtained multiple target behaviors according to the multiple behavior categories, and determine the behavior category to which the target behavior belongs.

In this embodiment, the behavior feature value of the behavior feature can be calculated using the following formula:

$${S}^{′} = max ( \frac{1}{\vert S \vert} {\sum }_{{x}_{i} ∈ S} I ( {x}_{i} ; y ) - \frac{1}{{\vert S \vert}^{2}} {\sum }_{{x}_{i} , {x}_{j} ∈ s} I ( {x}_{i} ; {x}_{j} ) )$$

Wherein, S is a feature subset of the behavior feature (the specific data corresponding to the feature subset which can be represented by a set of vectors). xᵢ, xⱼ are the behavior features in the feature subset S, where i=j=1, 2, . . . , n, and n represents the number of the feature vectors (i.e., the specific data of the number of the behavior features). y is a target variable (i.e., the performance of the student, such as “pass” or “fail”), I(xᵢ; y) indicates mutual information (MI) between the behavior feature xᵢ and the target variable y, I(xᵢ; xⱼ) indicates the MI between the behavior feature xᵢ and the behavior feature xⱼ, that is, the mutual information between any two behavior features.

In this embodiment, the data acquisition module 201 is configured to:
arrange the multiple behavior feature values obtained through calculation in a descending order, and obtain the behavior features corresponding to top N feature values as the target behaviors; or
obtain the behavior features corresponding to the multiple behavior feature values that are greater than a preset threshold as the target behaviors.

For example, 20 behavior features are obtained, and after the feature values of the 20 behavior features are calculated for feature selection, the 12 behavior feature with the highest scores are obtained. The 12 behavior features are then classified into 4 types based on the behavior category (such as the interactive behavior category, the constructive behavior category, the active behavior category, and the passive behavior category), that is, which category each behavior feature belongs to among the four types of behavior category is determined: the interactive behavior category, the constructive behavior category, the active behavior category, and the passive behavior category.

In this embodiment, a higher behavior feature value indicates a stronger correlation between the behavior feature and a prediction result. By screening multiple behavior features to identify the target behavior, feature factors that are highly correlated with the prediction result can be obtained, thereby improving both the accuracy and efficiency of prediction.

The data processing module 202 is configured to aggregate the learning behavior data corresponding to different target behaviors in a preset time unit, perform feature fusion on the aggregated data separately for each behavior category to obtain a category feature set, and determine the multiple category feature sets organized in chronological order as a category feature time series set.

In this embodiment, the preset time unit can be a week. That is, the learning behavior data corresponding to different target behaviors are aggregated on a weekly basis. For example, the data of a certain target behavior within a week is aggregated into a single value (such as the total number of clicks on a certain webpage within a week, which is used as the aggregated feature value for the week).

For example, the obtained learning behavior data of the student interacting with the learning platform forms a time sequence x1:L={x1, x2, . . . , xL}E RLXC with a length of L, wherein L indicates the length of the learning behavior time sequence (such as a learning duration based on a week unit or a day unit). xᵢ is an aggregated feature value of the learning behaviors within a i^{th} time period (such as each week in a week unit), and C is the number of the learning behaviors.

Wherein, each xᵢ∈R^{C} represents a feature vector of the learning behaviors within the i^{th} time period. The feature vector xᵢ=(xᵢ₁, xᵢ₂, . . . , x_{iC}), wherein xᵢⱼ represents the aggregated data of a j-th learning behaviors within the i^{th} time period.

The entire learning behavior time series x(1:L) can be represented as a matrix with a shape of L×C, wherein each row is a feature vector for a time period (such as one week):

$${x}_{( 1 : L )} = ( \begin{matrix}{x}_{11} & … & {x}_{1 C} \\ ⋮ & ⋱ & ⋮ \\ {x}_{L 1} & … & {x}_{LC}\end{matrix} ) .$$

The performing feature fusion on the aggregated data separately for each behavior category refers to performing the feature fusion on the aggregated data corresponding to the target behaviors within the same behavior category to obtain the category feature value for each behavior category. After the feature fusion is performed on all the behavior categories, the set of all category feature values forms the category feature set. The feature fusion is performed by: for each behavior category, calculating an average value of the aggregated data corresponding to the target behaviors within the same behavior category, and using the average value as the category feature for that behavior category. After the feature fusion is performed on all behavior categories, the obtained category features form a category feature set. All chronologically-organized category feature sets (i.e., the multiple category feature sets organized in chronological order) form the category feature time series set.

In the aforementioned x(1:L), if there are C learning behaviors in x₁₁ to x_{1c}, then the feature fusion is respectively performed on the data in x₁₁ to x_{1c} for each behavior category to obtain the category feature set.

For example, among C target behaviors, which target behaviors belong to the same behavior category is determined, and then the feature fusion is performed on the aggregated data of this behavior category to obtain the fused result as the category feature. If x₁₁ to x₁₅ all belong to Category A, then the feature fusion is performed on x₁₁ to x₁₅ (such as calculating the average of x₁₁ to x₁₅) to obtain the result as the category feature of Category A in the X₁ time period. Similarly, the feature fusion is performed on the data of L rows, that is, the data of rows x₁₁ to x_{L1} by behavior category to obtain the category feature time series set which includes L rows of data (representing L time periods), and each row of data has a category feature value of a different behavior category.

Furthermore, in an optional embodiment of the present disclosure, the data processing module 202 is configured to:
determine aggregation time periods to which all aggregated data belong; for the aggregated data within the same aggregation time period, select a maximum value of the aggregated data corresponding to the target behavior of the same behavior category as the category feature value for the same behavior category within the same aggregation time period; and
summarize the category feature values of each behavior category within each aggregation time period to obtain a category feature set.

In this implementation, the aggregation time period to which the aggregated data belongs is the time period corresponding to the value-aggregated data. For example, if there are 10 weeks of aggregated data corresponding to 10 different target behaviors, the aggregated data corresponding to different target behaviors in the first week belongs to the same aggregation time period, and the aggregated data corresponding to different target behaviors in the second week belongs to the same aggregation time period.

For example, there are 20 weeks of aggregated data. The target behaviors for a certain week include a behavior a, a behavior b, a behavior c, a behavior d, a behavior e, a behavior f, and a behavior g. The behavior a and the behavior b belong to a first behavior category, the behavior c and the behavior d belong to a second behavior category, the behavior e belongs to a third behavior category, and the behavior d belongs to a fourth behavior category. In the aggregated data, the maximum aggregated data from the behavior a and the behavior b is selected as the category feature value for the first behavior category of the week, and the maximum aggregated data from the behavior c and the behavior d is selected as the category feature value for the second behavior category of the week. The aggregated data from the behavior e is selected as the category feature value for the third behavior category of the week. The maximum aggregated data from the behavior f and the behavior g is selected as the category feature value for the fourth behavior category of the week.

In this embodiment, the category feature values of each behavior category within each aggregation time period are summarized to obtain a category feature set, which reduces the computational dimension compared to the step-by-step feature aggregation. Meanwhile, according to experimental results, such method improves the accuracy of the prediction result.

The feature reconstruction module 203 is configured to input the category feature time series set into a pre-trained feature reconstruction network to obtain a reconstructed time series set.

In this embodiment, the pre-trained feature reconstruction network is used to reconstruct the category feature time series set.

Experiments show that in this embodiment, the accuracy of the prediction result is improved after the reconstruction of the category feature time series set.

Furthermore, in an optional embodiment of the present disclosure, the feature reconstruction network is a feature distillation network.

In this embodiment, the feature distillation network can include a student network and a teacher network.

Furthermore, in an optional embodiment of the present disclosure, the feature distillation network includes: a first student LSTM, a feature distillation module, and a second student LSTM.

In this embodiment, the reconstructed time series set is outputted through the feature distillation module. The network structures of the first student LSTM and the second student LSTM can be identical.

The feature distillation network utilizes the input data as the training target, and is trained based on a backpropagation algorithm and an optimization algorithm to guide the network in extracting a temporal dependency and sequential information of the input sequence data. The LSTM unit is capable of processing a long sequence dependency, and includes a forget gate, an input gate, and an output gate that facilitate the memory and transmission of time series information. These gating mechanisms work together to ensure that the LSTM unit updates the state appropriately at each time step.

In this embodiment, the formula for the feature distillation network can be simplified as follows:

$$Z = LSTM ( X ) .$$

$$\hat{X} = LSTM ( Z ) .$$

As shown in FIG. 1, wherein X represents the input sequence and X={x₁, x₂, xᵢ}, wherein xᵢ is an original value input to the feature distillation network, \hat{X} is a predicted value output by the last layer of the neural network in the feature distillation network, Z is the reconstructed sequence output by the feature distillation module after the first student LSTM, and \hat{X} is a clone of the original input sequence. The feature distillation network utilizes a hidden state output by the previous LSTM layer (i.e., the first student LSTM) and then passes the hidden state to the last LSTM layer (i.e., the second student LSTM), which optimizes the LSTM unit through the backpropagation by minimizing the difference between the output value and the original input value.

In this embodiment, the feature distillation network is pre-trained. The training objective is to optimize the extraction of features (such as the category feature time series sets) of the input time sequence data by adjusting the network weights. Therefore, the training is unsupervised training, and the loss function is defined as the mean squared error between the input sequence and the output sequence.

The performance prediction module 204 is configured to input the reconstructed time series set into a pre-trained student performance prediction model to obtain the performance prediction results for the student.

The pre-trained student performance prediction model can be a BERT model. The BERT model employs a multi-head attention mechanism, and processes the input sequence through an attention mechanism, a residual connection with normalization, and a stacked feedforward neural network structure.

The specific content of the performance prediction results can vary depending on the task during model training. For example, the obtained performance prediction result for the student can be the result of passing or failing in a certain subject or multiple subjects at a certain time in the future.

Furthermore, in an optional embodiment of the present disclosure, the apparatus further includes a model training module configured to:
obtain training time series data before inputting the reconstructed time series set into the pre-trained student performance prediction model; and
perform joint training of the student performance prediction model for at least two tasks using the training time series data.

The training data can be the learning behavior data corresponding to different target behaviors among multiple behavior categories of multiple students.

Furthermore, the training data can be pre-processed through data cleaning and outlier removal. After being pre-processed, the training data is aggregated in a preset time unit and feature fusion within the same behavior category is performed. Additionally, a feature reconstruction network can be utilized for the reconstruction, and the reconstructed data then can be used to train the student performance prediction model.

In this embodiment, the accuracy of the prediction made by the student performance prediction model can be improved through the joint training.

Furthermore, in an optional embodiment of the present disclosure, the model training module is configured to:
mask some of the training time series data to obtain masked training time series data; and
perform the joint training of the student performance prediction model for at least two tasks using the masked training time series data and unmasked training time series data, wherein the joint training includes predicting original training time series data before masking for the masked training time series data and predicting student performance.

The masking some of the training time series data includes the following steps: randomly selecting 15% of the target training time series data from the entire training time series data for masking, and then performing the following operations on each piece of target training time series data: (1) randomly masking 80% of the sequences within each target training time series data (for example, replacing 80% of the sequences with a Masked sequence, which can be represented as an all-ones sequence); (2) Selecting 10% of the sequences and randomly replacing the selected sequences with sequences from the unmasked training time series data; (3) keeping 10% of the sequences unchanged.

Furthermore, the predicting original training time series data before masking for the masked training time series data includes predicting the masked training time series data and the corresponding original time series data before masking.

In this embodiment, the weights and biases in the model are updated through backpropagation of the neural network. In some embodiments, for Task 1 (predicting the original time series data before masking for the masked training time series data), a MSE loss function (i.e., the mean squared error loss function) can be used. For Task 2 (predicting the student performance), a multi-class cross-entropy loss function can be used.

Furthermore, in an optional embodiment of the present disclosure, the loss function of the joint training includes:

$${L}_{t o t a l} = \frac{1}{n} {\sum }_{i}^{n} {w}_{i} {L}_{i} .$$

Wherein, wᵢ is a learnable weight of Task i, and Lᵢ is a computational loss of Task i (i.e., a loss value calculated by the loss function of Task i).

In some embodiments, a value of w₁ (i.e., Task 1) is between 0.78 and 0.80, and A value of w₂ is between 0.65 and 0.72.

After initialization of wᵢ, the wights are updated every time the backpropagation of deep learning is continued, thereby simultaneously optimizing the two tasks and ensuring that the total loss is minimized as much as possible, avoiding simply combining the losses of the two tasks directly through addition. Furthermore, the emphasis on different tasks can be dynamically adjusted by learning the weights, thereby improving the prediction accuracy of the trained model.

In this embodiment, the joint training includes predicting the original time series data before masking for the masked training time series data, as well as predicting the student performance. Such bidirectional task allows each time series to indirectly observe itself, improving the bidirectional learning capability of the model. Therefore, the student performance prediction model in this embodiment is more powerful than shallow concatenation of left-to-right models or left-to-right and right-to-left models, and can improve the accuracy of the student performance prediction model.

The student performance prediction apparatus of the present disclosure is configured to: obtain the learning behavior data corresponding to different target behaviors among multiple behavior categories of the student within the preset time period; aggregate the learning behavior data corresponding to the different target behaviors in the preset time unit, perform feature fusion on the aggregated data separately for each behavior category to obtain the category feature set, and determine the multiple category feature sets organized in chronological order as the category feature time series set; input the category feature time series set into the pre-trained feature reconstruction network to obtain the reconstructed time series set; and input the reconstructed time series set into the student performance prediction model to obtain a performance prediction result for the student. The embodiment of the present disclosure can quickly predict the student performance based on the learning behavior data of the student without subjective evaluation from teachers, which allows the thinking ability of the learner to be predicted objectively and efficiently.

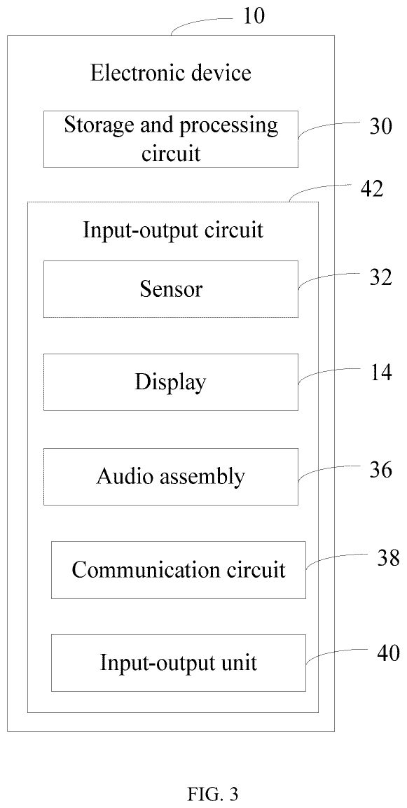

Referring to FIG. 3, which is a schematic diagram of the hardware structure of an electronic device in accordance with an embodiment of the present disclosure.

Illustratively, the electronic device may be any one of various types of computer system equipment that is mobile or portable and performs wireless communication. Specifically, the electronic device may be a mobile phone or a smart phone (for example, phone based on iPhone™, phone based on Android™), a portable game device (for example, Nintendo DS™, PlayStation Portable™, Gameboy Advance™, iPhone™), a laptop computer, a personal digital assistant (PDA), a portable Internet device, a data storage device, another handheld device, a watch, an earphone, a pendant, a headset, or the like. The electronic device may also be another wearable device (for example, electronic glasses, electronic clothes, an electronic bracelet, an electronic necklace, or a head-mounted devices (HMD) of a smart watch).

The electronic device may also be any one of a plurality of electronic devices. The plurality of electronic devices include but are not limited to a cell phone, a smartphone, another wireless communications device, a personal digital assistant, an audio player, another media player, a music recorder, a video recorder, a camera, another media recorder, a radio set, a medical device, a vehicle transportation instrument, a calculator, a programmable remote control, a pager, a laptop computer, a desktop computer, a printer, a netbook computer, a personal digital assistant (PDA), a portable multimedia player (PMP), a motion picture experts group (MPEG-1 or MPEG-2) audio layer (MP3) player, a portable medical device, a digital camera, or a combination thereof.

In some cases, the electronic device can perform multiple functions (such as playing music, displaying videos, storing pictures, and receiving and making phone calls). If necessary, the electronic device can be a portable device such as a cellular phone, a media player, another handheld device, a wristwatch device, a pendant device, an earpiece device, or another compact portable device.

As shown in FIG. 3, the electronic device 10 may include a control circuit, which may include a storage and processing circuit 30. The storage and processing circuit 30 may include a memory, such as a hard disk drive memory, a non-volatile memory (e.g., a flash memory or another electronically programmable memory with erasable restrictions which forms a solid-state drive), a volatile memory (such as a static or dynamic random access memory), and the embodiments of the present disclosure are not limited thereto. A processing circuit in the storage and processing circuit 30 can be used for controlling the operation of the electronic device 10. The processing circuit can be implemented based on one or multiple microprocessors, microcontrollers, digital signal processors, baseband processors, power management units, audio codec chips, application-specific integrated circuits, display driver integrated circuits, etc.

The storage and processing circuit 30 can be used to operate software of the electronic device 10, such as an Internet browsing application program, a voice over Internet protocol (VOIP) telephone call application program, an email application program, a media play application program, and an operating system function. Those software may be used to perform some control operations, such as image acquisition based on camera, ambient light measurement based on ambient light sensor, proximity sensor measurement based on proximity sensor, information display function implemented by status indicators such as status indicator light of LED, touch event detection based on touch sensor, functions associated with displaying information on multiple (for example, layered) displays, operations associated with performing wireless communication functions, operations associated with collecting and generating audio signals, control operations associated with collecting and processing button press event data, and other functions of the electronic device 10, etc., with no limitation set in the embodiment of the present disclosure.

Furthermore, the memory stores a executable program code, and the processor coupled to the memory calls the executable program code stored in the memory to execute the student performance prediction method described in the embodiment shown in FIG. 1 above.

The executable program code includes various modules in the student performance prediction apparatus described in the embodiment shown in FIG. 2 above, such as the data acquisition module, the data processing module, the feature reconstruction module, and the performance prediction module.

The electronic device 10 can further include an input-output circuit 42. The input-output circuit 42 can be configured to achieve data input and data output of the electronic device 10, that is, to allow the electronic device 10 to receive data from an external device and also allow the electronic device 10 to output data to an external device. The input-output circuit 42 can include a sensor 32. The sensor 32 may include an ambient light sensor, an optical or capacitive proximity sensor, a touch sensor (e.g., based on an optical touch sensor and/or a capacitive touch sensor, where the touch sensor may be a part of a touch display screen or may be used independently as a touch sensor structure), an acceleration sensor, a gravity sensor, and other sensors.

The input-output circuit 42 can further include one or more display devices, such as a display 14. The display 14 may include one or more of a liquid crystal display, an organic light emitting diode display, an electronic ink display, a plasma display, a combination of one or several types of displays using other display technologies. As an example, the display 14 may include an array of touch sensors (i.e., the display 14 can be a touch display screen). The touch sensor may be a capacitive touch sensor formed by an array of transparent touch sensor electrodes (e.g., indium tin oxide (ITO) electrodes), or may be a touch sensor formed with other touch technologies, such as acoustic touch, pressure sensitive touch, resistance touch, optical touch, and the like, and implementations of the present disclosure are not particularly restricted.

The electronic device 10 may further include an audio assembly 36. The audio assembly 36 can be used to provide audio input and output functions for the electronic device 10. The audio assembly 36 of the electronic device 10 may include a speaker, a microphone, a buzzer, a tone generator, and other components for generating and detecting sounds.

The communication circuit 38 can be used to provide the electronic device 10 with a capacity to communicate with external devices. The communication circuit 38 may include an analog and digital input-output interface circuit, and a wireless communication circuit based on radio frequency signals and/or optical signals. The wireless communication circuit included in the communication circuit 38 may include a radio frequency transceiver circuit, a power amplifier circuit, a low noise amplifier, a switch, a filter, and an antenna structure 19. For example, the wireless communication circuit included in the communication circuit 38 may include a circuit for supporting Near Field Communication (NFC) by transmitting and receiving near field coupled electromagnetic signals. For example, the communication circuit 38 may include a near field communication antenna and a near field communication transceiver. The communication circuit 38 may also include a cellular telephone transceiver, a wireless local area network transceiver circuit, and the like.

The electronic device 10 may further include a battery, a power management circuit, and other input-output units 40. The input-output unit 40 can include buttons, joysticks, click wheels, scroll wheels, touchpads, keypads, keyboards, cameras, light-emitting diodes (LEDs), and other status indicators.

Users can control the operation of the electronic device 10 by inputting commands through the input-output circuit 42, and the output data of the input-output circuit 42 can be used to receive status information and other outputs from the electronic device 10.

Furthermore, the embodiments of the present disclosure also provide a computer-readable storage medium, which can be arranged in the electronic device of the above embodiments. The computer-readable storage medium can be the memory in the storage and processing circuit 30 of the embodiment shown in FIG. 3. The computer-readable storage medium stores a computer program, which, when executed by a processor, implements the student performance prediction method described in the embodiment shown in FIG. 1. Furthermore, the computer-readable storage medium can also be various media capable of storing program code, such as a USB flash drive, a mobile hard disk, a read-only memory (ROM), a random access memory (RAM), a magnetic disk, or an optical disk.

It is to be noted that, for the sake of simplicity, the foregoing method implementations are described as a series of action combinations, however, it will be appreciated by those skilled in the art that the present disclosure is not limited by the sequence of actions described. According to the present disclosure, certain steps or operations may be performed in other order or simultaneously. Besides, it will be appreciated by those skilled in the art that the implementations described in the specification are exemplary implementations and the actions and modules involved are not necessarily essential to the present disclosure.

In the foregoing implementations, the description of each implementation has its own emphasis. For the parts not described in detail in one implementation, reference may be made to related descriptions in other implementations.

The above is a description of the student performance prediction method, apparatus, and computer-readable storage medium provided by the present disclosure. For those skilled in the art, based on the ideas of the embodiments of the present disclosure, there will be changes in specific implementation methods and application scopes. In summary, the content of this specification should not be understood as a limitation of the present disclosure.

1. A student performance prediction method, comprising:
obtaining learning behavior data corresponding to different target behaviors among multiple behavior categories of a student within a preset time period;
aggregating the learning behavior data corresponding to the different target behaviors in a preset time unit, and performing feature fusion on the aggregated data separately for each behavior category to obtain a category feature set, and determining the multiple category feature sets organized in chronological order as a category feature time series set;
inputting the category feature time series set into a pre-trained feature reconstruction network to obtain a reconstructed time series set; and
inputting the reconstructed time series set into a student performance prediction model to obtain a performance prediction result for the student.

2. The student performance prediction method according to claim 1, wherein, before the inputting the reconstructed time series set into a pre-trained student performance prediction model, the method further comprises:
obtaining training time series data; and
performing joint training of the student performance prediction model for at least two tasks using the training time series data.

3. The student performance prediction method according to claim 2, wherein the performing the joint training of the student performance prediction model for at least two tasks using the training time series data comprises:
masking some of the training time series data to obtain masked training time series data; and
performing the joint training of the student performance prediction model for at least two tasks using the masked training time series data and unmasked time series data, wherein the joint training of the student performance prediction mode comprises predicting original time series data before masking for the masked training time series data and predicting student performance.

4. The student performance prediction method according to claim 1, wherein, before the obtaining learning behavior data corresponding to different target behaviors among multiple behavior categories of a student within a preset time period, the method further comprises:
obtaining behavior data of multiple behavior features;
calculating behavior feature values of the behavior features based on the behavior data;
determining the behavior feature corresponding to the behavior feature value satisfying a preset first condition as the target behavior; and
classifying the obtained multiple target behaviors according to the multiple behavior categories, and determining the behavior category to which the target behavior belongs.

5. The student performance prediction method according to claim 1, wherein the performing feature fusion on the aggregated data separately based on the behavior categories to obtain a category feature set comprises:
determining aggregation time periods to which all aggregated data belongs, and for the aggregated data within a same aggregation time period, selecting a maximum value of the aggregated data corresponding to the target behavior of the same behavior category as a category feature value of the same behavior category within the same aggregation time period; and
summarizing the category feature values of each behavior category within each aggregation time period to obtain the category feature set.

6. The student performance prediction method according to claim 1, wherein the feature reconstruction network is a feature distillation network.

7. The student performance prediction method according to claim 1, wherein the multiple behavior categories comprise four types of behavior category which comprises an interactive behavior category, a constructive behavior category, an active behavior category, and a passive behavior category.

8. A student performance prediction apparatus, comprising:
a data acquisition module, configured to obtain learning behavior data corresponding to different target behaviors among multiple behavior categories of a student within a preset time period;
a data processing module, configured to aggregate the learning behavior data corresponding to different target behaviors in a preset time unit, perform feature fusion on the aggregated data separately for each behavior category to obtain a category feature set, and determine the multiple category feature sets organized in chronological order as a category feature time series set;
a feature reconstruction module, configured to input the category feature time series set into a pre-trained feature reconstruction network to obtain a reconstructed time series set; and
a performance prediction module, configured to input the reconstructed time series set into a student performance prediction model to obtain a performance prediction result for the student.

9. An electronic device comprising a memory, a processor, and a computer program stored in the memory and capable of running in the processor, wherein, when being executed by the processor, the computer program implements the steps in the student performance prediction method according to claim 1.

10. An electronic device comprising a memory, a processor, and a computer program stored in the memory and capable of running in the processor, wherein, when being executed by the processor, the computer program implements the steps in the student performance prediction method according to claim 2.

11. An electronic device comprising a memory, a processor, and a computer program stored in the memory and capable of running in the processor, wherein, when being executed by the processor, the computer program implements the steps in the student performance prediction method according to claim 3.

12. An electronic device comprising a memory, a processor, and a computer program stored in the memory and capable of running in the processor, wherein, when being executed by the processor, the computer program implements the steps in the student performance prediction method according to claim 4.

13. An electronic device comprising a memory, a processor, and a computer program stored in the memory and capable of running in the processor, wherein, when being executed by the processor, the computer program implements the steps in the student performance prediction method according to claim 5.

14. An electronic device comprising a memory, a processor, and a computer program stored in the memory and capable of running in the processor, wherein, when being executed by the processor, the computer program implements the steps in the student performance prediction method according to claim 6.

15. An electronic device comprising a memory, a processor, and a computer program stored in the memory and capable of running in the processor, wherein, when being executed by the processor, the computer program implements the steps in the student performance prediction method according to claim 7.

16. A computer-readable storage medium with a computer program stored thereon, wherein, when being executed by the processor, the computer program implements the steps in the student performance prediction method according to claim 1.

17. A computer-readable storage medium with a computer program stored thereon, wherein, when being executed by the processor, the computer program implements the steps in the student performance prediction method according to claim 2.

18. A computer-readable storage medium with a computer program stored thereon, wherein, when being executed by the processor, the computer program implements the steps in the student performance prediction method according to claim 3.

19. A computer-readable storage medium with a computer program stored thereon, wherein, when being executed by the processor, the computer program implements the steps in the student performance prediction method according to claim 4.

20. A computer-readable storage medium with a computer program stored thereon, wherein, when being executed by the processor, the computer program implements the steps in the student performance prediction method according to claim 5.
